(19) United States
(12) Patent Application Publication
(10) Pub. No.: US 2011/0013122 A1
(43) Pub. Date: Jan. 20, 2011

(54) DISPLAY DEVICE, POLARIZATION MEMBER AND MANUFACTURING METHOD THEREOF

(76) Inventors: Sungwoo Kim, Gyeonggi-do (KR); Jongbyuck Lee, Kyungbuk (KR); Jungeun Son, Seoul (KR)

Correspondence Address: MORGAN LEWIS & BOCKIUS LLP, 1111 PENNSYLVANIA AVENUE NW, WASHINGTON, DC, 20004, US

(21) Appl. No.: 12/835,172

(22) Filed: Jul. 13, 2010

(30) Foreign Application Priority Data
Jul. 16, 2009 (KR) 10-2009-0065043

(51) Int. Cl. G02F 1/1335; B32B 37/16; G02B 5/30

(52) U.S. Cl. 349/96; 156/306.6; 359/485

(57) ABSTRACT

Provided is a display panel including a polarization member having both-sided adhesiveness to attach a display surface of a first panel to a display surface of a second panel to each other.

This application claims the benefit of Korean Patent Application No. 10-2009-0065043 filed on Jul. 16, 2009, which is hereby incorporated by reference.

### BACKGROUND

1. Field

This document relates to a display device, a polarization member and a manufacturing method thereof.

2. Related Art

With the development of multimedia, flat panel displays become important. Accordingly, a variety of flat panel displays such as liquid crystal display, plasma display device, organic light emitting display, and the like are put to practical use. Among these display devices, the liquid crystal display and the organic light emitting display, for example, are manufactured in such a manner that elements and interconnecting lines are formed in the form of a thin film on a substrate through a deposition method, an etching method, etc.

In recent years, a method of attaching two panels to construct a flat panel display so as to use the flat panel display as a both-sided display or a 3D display have been studied. Here, the two-sided display can display images on both sides of a display panel such that users can view the images displayed on the two sides of the display. The 3D display can display 3D images on a display panel, and thus users can view the 3D images according to control of the two panels.

Conventional flat panel displays were manufactured by attaching two panels using a material such as epoxy or resin. In this case, an additional process for attaching the two panels to each other is required and the panels may be damaged or the thickness of the attached panels increase to result in deterioration of the quality of displayed images.

### SUMMARY

An aspect of this document is to provide a display device comprising a polarization member having both-sided adhesiveness to attach a display surface of a first panel to a display surface of a second panel to each other.

In an aspect, a polarization member comprises a first both-sided adhesive tape attached to the first display surface of the first panel; a second both-sided adhesive tape attached to the second display surface of the second panel; and a polarizer interposed between the first both-sided adhesive tape and the second both-sided adhesive tape.

In another aspect, a method of manufacturing a display device comprises forming a first panel; forming a second panel; and placing a polarization member having both-sided adhesiveness between a first display surface of the first panel and a second display surface of the second panel and attaching the first display surface of the first panel to the second display surface of the second panel to each other.

### BRIEF DESCRIPTION OF THE DRAWINGS

The implementation of this document will be described in detail with reference to the following drawings in which like numerals refer to like elements.

FIG. 1 is a cross-sectional view of a display device;

FIGS. 2 and 3 are cross-sectional views of polarization members;

FIG. 4 illustrates a configuration of a 3D display device;

FIG. 5 is a circuit diagram of a sub pixel included in a first panel shown in FIG. 4;

FIG. 6 illustrates structures of electrodes included in a second panel shown in FIG. 4; and

FIG. 7 illustrates an exemplary 3D mode operation of the 3D display device shown in FIG. 4.

### DETAILED DESCRIPTION

Hereinafter, an implementation of this document will be described in detail with reference to the attached drawings.

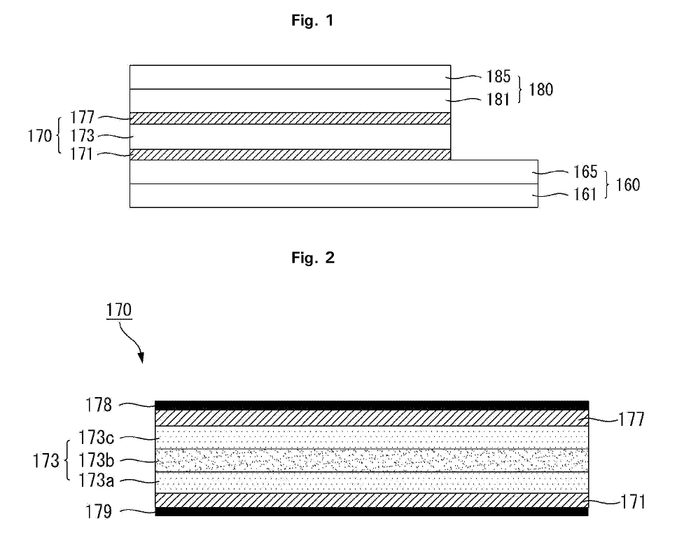

Referring to FIGS. 1, 2 and 3, a display device includes a polarization member 170 having both-sided adhesiveness to attach a first display surface of a first panel 160 to a second display surface of a second panel 180 to each other. The first panel 160 and the second panel 180 may be attached to each other by locating the polarization member 170 having the both-sided adhesiveness between the first display surface of the first panel 160 and the second display surface of the second panel 180.

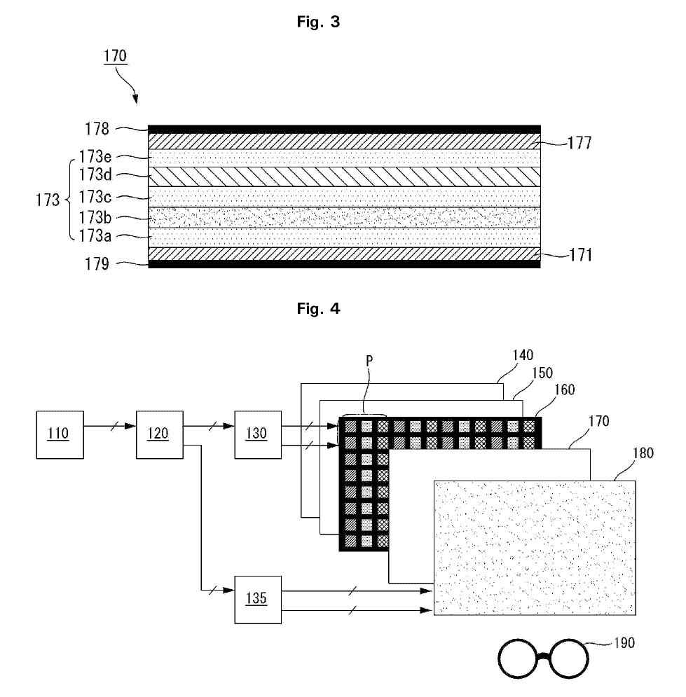

The polarization member 170 may include a first both-sided adhesive tape 171 attached to the first display surface of the first panel 160, a second both-sided adhesive tape 177 attached to the second display surface of the second panel 180, and a polarizer 173 interposed between the first both-sided adhesive tape 171 and the second both-sided adhesive tape 177. The polarizer 173 includes a first film 173a, a second film 173b, and a third film 173c, as shown in FIG. 2. The polarizer 173 transmits only light having a vibrating surface in a specific direction among natural lights having vibrating surfaces in direction of 360° and absorbs remaining lights to provide polarized lights to the second panel 180. For example, the polarizer 173 is formed through stretching and the first film 173a and the third film 173c are formed from a triacetate cellulose (TAC) film and the second film 173b are formed from a poly vinyl alcohol (PVA) film. The polarizer 173 may further includes a fourth film 173d disposed on the third film 173c and formed of a half wave plate (HWP) film and a fifth film 173e placed on the fourth film 173d and formed from a TAC film, as shown in FIG. 3. However, the polarizer 173 is not limited thereto. The first both-sided adhesive tape 171 and the second both-sided adhesive film 177 included in the polarization member 170 may be protected by a first protecting film 178 and a second protecting film 179. The first protecting film 178 and the second protecting film 179 may be removed when the first display surface of the first panel 160 and the second display surface of the second panel 180 are attached to each other.

At least one of the first panel 160 and the second panel 180 may be selected as an LCD panel that displays an image in response to a data signal and a scan signal. Otherwise, at least one of the first panel 160 and the second panel 180 may be selected as an organic light emitting display panel. When the first panel 160 and the second panel 180 are selected as a display panel, the first panel 160 and the second panel 180 construct a both-sided display device that displays images through both sides of the two panels. If the first panel 160 is selected as a display panel and the second panel 180 is selected as a control panel that separates an image projected from the first panel into optical axes of left and right disparity images, the first panel 160 and the second panel 180 construct a 3D display device displaying 3D images. In this document, the first panel 160 is selected as an LCD panel having two substrates 161 and 165 attached to each other and the second panel 180 is selected as a control panel having two substrates 181 and 185 attached to each other to construct a 3D display device. Although the 3D display device is classified into a glass type and a glassless type, a glass type 3D display device is described in this document.

The 3D display device will now be explained.

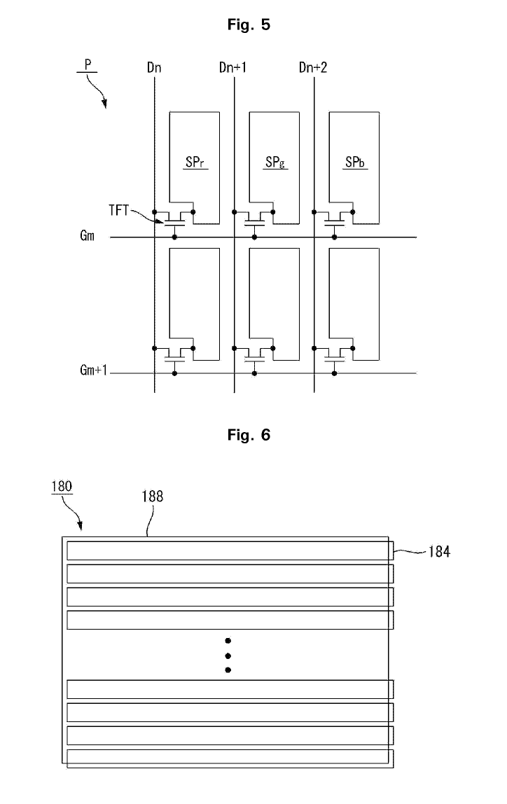

Referring to FIGS. 4, 5 and 6, the 3D display device includes an image providing unit 110, a controller 120, a first driver 130, a second driver 135, a back light unit 140, a lower polarization member 150, the first panel 160, the polarization member 170, the second panel 180, and polarization glasses 190.

The image providing unit 110 provides image data in a 2D format to the controller 120 in a 2D mode and provides right-eye/left-eye image data to the controller 120 in a 3D mode. Furthermore, the image providing unit 110 supplies timing signals including a vertical synchronization signal, a horizontal synchronization signal, a data enable signal, a main clock signal, and a low voltage GND to the controller 120. The image providing unit 110 selects the 2D mode or the 3D mode according to a user's selection input through a user interface. The user interface includes user input units including an on-screen display (OSD), a remote controller, a keyboard, mouse, ant the like. The image providing unit 110 may divide left-eye and right-eye images displayed on the first panel 160 into left-eye image data and right-eye image data in the 3D format and encode the left-eye image data and the right-eye image data.

The controller 120 provides first image data and second image data to the first panel 160. The first image data may be selected as the left-eye image data and the second image data may be selected as the right-eye image data. The controller 120 may provide image data input from the image providing unit 110 to the first driver 130 at a frame frequency of 60×n (n is a positive integer equal to or greater than 2). The controller 120 alternately provides the left-eye image data and the right-eye image data to the first driver 130 in the 3D mode. The controller 120 may multiply the frame frequency of an input image by n to increase a timing control signal frequency for controlling operating timings of the first and second drivers 130 and 135. Furthermore, the controller 120 controls the second driver 135 such that the voltage of scan lines 184 formed on the second panel 180 is changed from a first driving voltage to a second driving voltage along a line in the first panel on which a left-eye image and a right-eye image are changed.

The first driver 130 includes a data driving circuit connected to data lines Dn, Dn+1 and Dn+2 and a gate driving circuit connected to gate lines Gm and Gm+1. The data driving circuit transforms digital video data input from the controller 120 into a positive/negative analog video data voltage and provides the positive/negative analog video data voltage to the data lines Dn, Dn+1 and Dn+2 under the control of the controller 120. The gate driving circuit sequentially provides gate pulses (or scan pulses) to the gate lines Gm and Gm+1 under the control of the controller 120.

The second driver 135 shifts a switching voltage Von/Voff supplied to the scan lines 184 along the boundary of left-eye image data and right-eye image data in the first panel 160. The second driver 135 may be implemented as a multiplexer array that selects the voltage Voff synchronized with the left-eye image data displayed on the first panel 160 and the voltage +Von/−Von synchronized with the right-eye image data displayed on the first panel 160 under the control of the controller 120. The second driver 135 may be implemented as a shift register and a level shifter for shifting the output of the shift register to the voltage Voff or +Von/−Von. Furthermore, the second driver 135 may be implemented as any analog/digital circuit capable of sequentially supplying the voltage Voff or +Von/−Von to the scan lines 184 of the second panel 180.

The first panel 160 displays the first image data during an Nth frame period (N is a positive integer) and displays the second image data during an (N+1)th frame period. The first panel 160 may be implemented as an LCD panel. The first panel 160 includes a thin film transistor (TFT) substrate and a color filter substrate. A liquid crystal layer is formed between the TFT substrate and the color filter substrate. The TFT substrate includes a lower substrate on which the data lines Dn, Dn+1 and Dn+2 and the gate lines Gm and Gm+1 are formed in an intersecting manner and sub pixels Spr, Spg and Spb defined by the data lines Dn, Dn+1 and Dn+2 and the gate lines Gm and Gm+1 are arranged in an matrix form. TFTs formed at intersections of the data lines Dn, Dn+1 and Dn+2 and the gate lines Gm and Gm+1 transfer data voltages provided through the data lines Dn, Dn+1 and Dn+2 to pixel electrodes of liquid crystal cells in response to a scan pulse from the gate line Gm. To achieve this, gate electrodes of the TFTs are connected to the gate line Gm and source electrodes thereof are connected to the data line Dn. Drain electrodes of the TFTs are respectively connected to the pixel electrodes of the liquid crystal cells. A common voltage is supplied to a common electrode corresponding to the pixel electrodes. The color filter substrate includes an upper substrate on which a black matrix and a color filter are formed. The common electrode is formed on the upper substrate in a vertical field driving mode including a twisted nematic (TN) mode and a vertical alignment (VA) mode and formed together with the pixel electrodes on the lower substrate in a horizontal field driving mode including an in-plane switching (IPS) mode and a fringe field switching (FFS) mode. The first panel 160 includes an alignment film for setting a pre-tilt angle of liquid crystal. The lower polarization member 150 is attached to one side of the first panel 160, which faces the back light unit 140, and the polarization member 170 is attached the other side of the first panel, which faces the second panel 180. The lower polarization member 150 determines the polarization property of light input to the first panel 160. The polarization member 170 has a light-absorbing axis corresponding to the light-absorbing axis of a left-eye or right-eye polarization filter of the polarization glasses 190 and determines the polarization property of light input to the second panel 180 through the light-absorbing axis. Spacers for maintaining a cell gap of the liquid crystal layer are formed between the upper substrate and the lower substrate of the first panel 160. The first panel 160 may have any liquid crystal mode as well as the aforementioned TN mode, VA mode, IPS mode, and FFS mode. When the first panel 160 is used to construct an LCD, the LCD may be implemented as a transmissive LCD, a semi-transmissive LCD and reflective LCD. The transmissive LCD and the semi-transmissive LCD require the back light unit 140. The first panel 160 projects linearly polarized light or circularly polarized light.

The second panel 180 converts light from the first panel 160 into a first polarized light in response to the first driving voltage during the Nth frame period and converts the light from the first panel 160 into a second polarized light in response to the second driving voltage during the (N+1)th frame period. To achieve this, the second panel 180 includes an upper substrate (or transparent substrate) and a lower substrate (or transparent substrate) facing each other having a liquid crystal layer interposed between them. The upper substrate may include a common electrode 188 formed thereon and the lower substrate may include the scan lines 184 formed thereon in a horizontal stripe pattern. The scan lines 184 formed in the second panel 180 may be arranged in the same direction as the gate lines Gm and Gm+1 formed in the first panel 160 such that the scan lines 184 correspond to the gate lines Gm and Gm+1 in the ratio of 1:N (N is an even number). For example, if the first panel 160 has 1080 gate lines and the second panel 180 has 90 scan lines, a single scan line corresponds to 12 gate lines. The common electrode 188 is provided with a common voltage equivalent to the common voltage supplied to the common electrode of the first panel 160. The scan lines 184 may be provided with the voltage Voff equivalent to the common voltage before (or after) a light-eye image (or left-eye image) is displayed on lines of the first panel 160, which correspond to the scan lines 184. The scan lines 184 may be alternately provided with positive/negative voltages +Von/−Von that are higher and lower than the common voltage by a predetermined voltage before (or after) a left-eye image (or right-eye image) is displayed on lines of the first panel 160, which correspond to the scan lines 184. Accordingly, switching on/off voltages of 3-step voltage levels may be supplied to the scan lines 184 such that right-eye and left-eye images displayed on the first panel 160 can be viewed through the polarization glasses 190. The positive/negative voltages +Von/−Von generated on the basis of the common voltage prevent deterioration of liquid crystal due to a DC voltage. The common voltage supplied to the common electrode of the first panel 160 and the voltage Von or Voff supplied to the common voltage 188 and the scan lines 184 of the second panel 180 may be set to 7.5V and the voltages +Von and −Von provided to the scan lines 184 of the second panel 180 may be respectively set to 15V and 0V.

The polarization glasses 190 include left-eye and right-eye glasses having different light-absorbing axes such that polarization properties of left and right eyes are different from each other. The polarization glasses 190 may be constructed according to the structures of the first panel 160 and the second panel 180.

An exemplary operation of the aforementioned 3D display device will now be explained in detail.

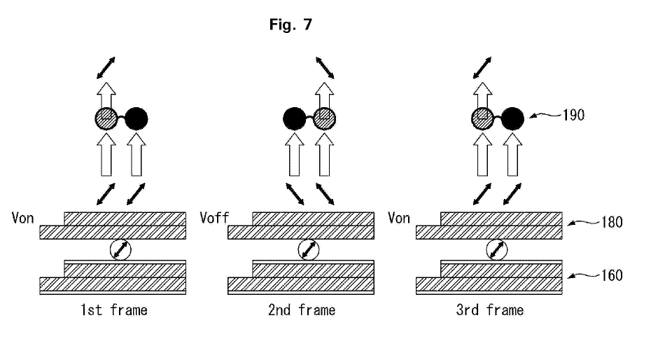

FIG. 7 illustrates how left-eye and right-eye images that pass through the first panel 160 and the second panel 180 are viewed through the polarization glasses 90 by frames. Referring to FIGS. 1 through 7, the first panel 160 alternately displays the left-eye image and the right-eye image in the 3D mode and transmits lights of the left-eye image and the right-eye image through the polarization member 170 as left polarized lights. The second panel 180 retards the phase of the left polarized lights from the first panel 160 by 90° and transmits right polarized lights to the polarization glasses 190 when the voltage Voff is supplied to the scan lines 184. The second panel 180 transmits the left polarized lights from the first panel without having phase retardation when the voltages +Von/−Von are supplied to the scan lines 184. Accordingly, if the first panel 160 and the second panel 180 are driven at a frame frequency of 120 Hz, the first panel 160 displays the left-eye image during an odd frame period and displays the right-eye image during an even frame period. Then, a viewer can see the left-eye image during the odd frame and see the right-eye image during the even frame period by wearing the polarization glasses 190. The left polarized lights may be vertically linearly polarized lights (or horizontally linearly polarized lights) or a left circularly polarized lights (or right circularly polarized lights) and may be horizontally linearly polarized lights (or vertically linearly polarized lights) or a right circularly polarized lights (or left circularly polarized lights) having an optical axis perpendicular to the optical axis of the right polarized lights. The first panel 160 displays an image in the 2D format in the 2D mode. If the first panel 160 displays the image in the 2D format, the viewer can see the 2D format image when taking off the polarization glasses 190.

The aforementioned display device, the polarization member and the manufacturing method thereof may attach two panels to each other using the both-sided adhesive tapes to omit an additional process, for example, a process of forming a layer using epoxy or resin, and thus the manufacturing process can be simplified and productivity can be improved. Furthermore, the two panels are attached to each other using the both-sided adhesive polarization member to achieve a thin display device. Accordingly, deterioration of visibility caused by an increase in the thickness of a rear panel can be prevented when 3D images are displayed.

The foregoing embodiments and advantages are merely exemplary and are not to be construed as limiting this document. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A display device comprising a polarization member having both-sided adhesiveness to attach a first display surface of a first panel to a second display surface of a second panel to each other.

2. The display device of claim 1, wherein the polarization member comprises:
a first both-sided adhesive tape attached to the first display surface of the first panel;
a second both-sided adhesive tape attached to the second display surface of the second panel; and
a polarizer interposed between the first both-sided adhesive tape and the second both-sided adhesive tape.

3. The display device of claim 2, wherein the polarizer comprises:
a first film formed from a triacetate cellulose (TAC) film;
a second film disposed on the first film and formed from a poly vinyl alcohol (PVA) film;
a third film disposed on the second film and formed from a TAC film;
a fourth film disposed on the third film and formed from a half wave plate (HWP) film; and
a fifth film disposed on the fourth film and formed from a TAC film.

4. The display device of claim 1, wherein one of the first panel and the second panel is a liquid crystal display panel that displays an image in response to a data signal and a scan signal and the other is a control panel that separates the image into optical axes of left and right disparity image.

5. The display device of claim 1, wherein if the first panel is a liquid crystal display panel, the second panel is a control panel that separates an image projected by the first panel into optical axes of left and right disparity images.

6. The display device of claim 1, wherein the first panel comprises a lower polarization member attached to the first panel to polarize lights emitted from a back light unit located opposite to the side of the first panel, to which the polarization member is attached.

7. A polarization member comprising:
a first both-sided adhesive tape;
a second both-sided adhesive tape; and
a polarizer interposed between the first both-sided adhesive tape and the second both-sided adhesive tape.

8. The polarization member of claim 7, wherein the polarizer comprises:
a first film formed from a TAC film;
a second film disposed on the first film and formed from a PVA film;
a third film disposed on the second film and formed from a TAC film;
a fourth film disposed on the third film and formed from a HWP film; and
a fifth film disposed on the fourth film and formed from a TAC film.

9. A method of manufacturing a display device, comprising:
forming a first panel;
forming a second panel; and
placing a polarization member having both-sided adhesiveness between a first display surface of the first panel and a second display surface of the second panel and attaching the first display surface of the first panel to the second display surface of the second panel to each other.

10. The method of claim 9, wherein if the first panel is a liquid crystal display panel, the second panel is a control panel that separates an image projected by the first panel into optical axes of left and right disparity images.

11. The method of claim 9, wherein the polarization member comprises:
a first both-sided adhesive tape attached to the first display surface of the first panel;
a second both-sided adhesive tape attached to the second display surface of the second panel; and
a polarizer interposed between the first both-sided adhesive tape and the second both-sided adhesive tape.

12. The method of claim 9, wherein the polarizer comprises:
a first film formed from a TAC film;
a second film disposed on the first film and formed from a PVA film;
a third film disposed on the second film and formed from a TAC film;
a fourth film disposed on the third film and formed from a HWP film; and
a fifth film disposed on the fourth film and formed from a TAC film.

13. The method of claim 9, wherein if the first panel is a liquid crystal display panel, the second panel is a control panel that separates an image projected by the first panel into optical axes of left and right disparity images.
